(19) United States
(12) Patent Application Publication
(10) Pub. No.: US 2026/0363322 A1
(43) Pub. Date: Nov. 19, 2026

(54) AEROSOL PROVISION DEVICE

(71) Applicant: Nicoventures Trading Limited, London (GB)

(72) Inventors: Jorge GOMEZ, London (GB); Matthew HOLDEN, London (GB); Conor MCGRATH, London (GB); Jonathan BURGESS, London (GB)

(21) Appl. No.: 19/753,907

(22) Filed: Jul. 24, 2026

Related U.S. Application Data
(63) Continuation of application No. 18/723,443, filed on Dec. 19, 2022.

(30) Foreign Application Priority Data
Dec. 23, 2021 (GB) 2118894.1

(51) Int. Cl. A24F 40/465; A24F 40/485; A24F 40/20

(52) U.S. Cl. CPC A24F 40/465; A24F 40/485; A24F 40/20

(57) ABSTRACT

An aerosol provision device includes a receptacle arranged to receive at least a portion of an article including aerosol generating material. The receptacle has a heating element defining a heating zone arranged to receive a first part of the portion of the article receivable in the receptacle and a base member at an end of the heating element. The base member defines an end zone arranged to receive at least a second part of the portion of the article receivable in the receptacle. The base member is free from material heatable by penetration with a varying magnetic field.

### RELATED APPLICATIONS

The present application is a continuation of U.S. Patent Application No. 18/723,443, filed Jun. 23, 2024, which is a National Phase entry of PCT Application No. PCT/EP2022/086803 filed Dec. 19, 2022, which claims priority to GB Application No. 2118894.1 filed Dec. 23, 2021, each of which is hereby incorporated by reference in their entirety.

### TECHNICAL FIELD

The present invention relates to an aerosol provision device and an aerosol provision system comprising an aerosol provision device and an article comprising aerosol generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

In accordance with some embodiments described herein, there is provided an aerosol provision device comprising: a receptacle arranged to receive at least a portion of an article comprising aerosol generating material; the receptacle comprising a heating element defining a heating zone arranged to receive a first part of the portion of the article receivable in the receptacle and a base member at an end of the heating element; wherein the base member defines an end zone arranged to receive at least a second part of the portion of the article receivable in the receptacle; and wherein the base member is free from material heatable by penetration with a varying magnetic field.

The base member may comprise an air path extending through the base member.

The base member may define an end wall of the receptacle.

The air path extends through the end wall.

The base member may comprise a peripheral wall.

The peripheral wall may define a cavity arranged to receive at least the second part of the portion of the article.

The peripheral wall may extend from the heating element.

The peripheral wall may partially overlap the heating element.

The peripheral wall may comprise a first portion overlapping the heating element and a second portion extending from the heating element. The second portion may define the end zone.

An axial length of the heating zone may be greater than an axial length of the end zone.

The axial length of the heating zone may be at least four times greater than an axial length of the end zone.

A cross sectional profile of the end zone may correspond to a cross sectional profile of the heating zone.

A diameter of the end zone may correspond to a diameter of the heating zone

The heating element may be a tubular member

The base member may be an end support arranged to support an end of the heating element.

The end support may be a first end support at a first end of the heating element and the device may comprise a second end support at a second end of the heating element.

The base member may be formed from an insulating material. The insulating material may be a thermally insulating material.

The second end support may comprise an article insertion aperture.

The base member may comprise a shoulder arranged to limit insertion of the at least a portion of an article into the receptacle.

The base member may comprise a retention feature. The retention feature may be an article retention feature. The retention feature may protrude into the end zone. The retention feature may comprise at least one rib.

A length of the end zone may be greater than 0.5mm, and optionally greater than 1 mm. A length of the end zone may be between 0.5 mm and 6 mm, and optionally between 1 mm and 4 mm. A length of the end zone may be greater than 4 mm.

The aerosol provision device may comprise an inductor coil.

The inductor coil may encircle at least part of the heating element.

The heating element may form part of an aerosol generator.

The aerosol generator may comprise a fluidly sealed cavity adjacent to the heating element. The aerosol provision device may comprise a sensor in the fluidly sealed cavity. The sensor may be a thermocouple. The thermocouple may be on the heating element.

In use, the inductor coil may be configured to heat the heating element to a temperature of between about 200 ºC and about 300 ºC such as between about 240 ºC and about 300 ºC, or between about 250 ºC and about 280 ºC. When the outer cover is spaced apart from the susceptor by at least this distance, the temperature of the outer cover remains at a safe level, such as less than about 60 ºC, less than about 50 ºC, or less than about 48 ºC, or less than about 43 ºC. In use, the inductor coil may be configured to heat the heating element to a temperature of about 350 ºC.

The inductor coil may be substantially helical. The inductor coil may be a spiral coil. For example, the inductor coil may be formed from wire, such as Litz wire, which is wound helically around the coil support. The wire may be a solid wire.

Reference to an “outer surface” of an entity means the surface positioned furthest away from the axis of the heating element, in a direction perpendicular to the axis. Similarly, reference to an “inner surface” of an entity means the surface positioned closest to the axis of the heating element, in a direction perpendicular to the axis.

The end member may be formed from polyether ether ketone (PEEK). PEEK has good insulating properties and is well suited for use in an aerosol provision device.

The end member may have a thermal conductivity of less than about 0.5 W/mK, or less than about 0.4 W/mK. For example, the thermal conductivity may be about 0.3 W/mK. PEEK has a thermal conductivity of about 0.32W/mK.

The end member may have a melting point of greater than about 320 ºC, such as greater than about 300 ºC, or greater than about 340 ºC. PEEK has a melting point of 343 ºC.

The device may be a tobacco heating device, also known as a heat-not-burn device.

In accordance with some embodiments described herein, there is provided an aerosol provision device comprising: a receptacle arranged to receive at least a portion of an article comprising aerosol generating material; the receptacle comprising a heating element defining a heating zone arranged to receive a first part of the portion of the article receivable in the receptacle and a base member at an end of the heating element; wherein the base member defines an end zone arranged to receive at least a second part of the portion of the article receivable in the receptacle; and wherein the base member is formed from an insulating material and free from a heating material.

In accordance with some embodiments described herein, there is provided an aerosol provision system comprising: an aerosol provision device as described in any of the above; and an article comprising aerosol generating material, wherein the article is dimensioned to be at least partially received within the receptacle.

### BRIEF DESCRIPTION OF THE DRAWINGS

Embodiments of the invention will now be described, by way of example only, with reference to accompanying drawings, in which:

FIG. 1 shows a front view of an aerosol provision device;

FIG. 2 shows a schematic side view of an aerosol generator of the device of FIG. 1; and

FIG. 3 shows a cross-sectional side view of an air flow path of the aerosol generator of FIG. 2.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavorants. Aerosol-generating material may include any plant based material, such as tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50wt%, 60wt% or 70wt% of amorphous solid, to about 90wt%, 95wt% or 100wt% of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

An aerosol generating device can receive an article comprising aerosol generating material for heating. An “article” in this context is a component that includes or contains in use the aerosol generating material, which is heated to volatilize the aerosol generating material, and optionally other components in use. A user may insert the article into the aerosol generating device before it is heated to produce an aerosol, which the user subsequently inhales. The article may be, for example, of a predetermined or specific size that is configured to be placed within a heating chamber of the device which is sized to receive the article.

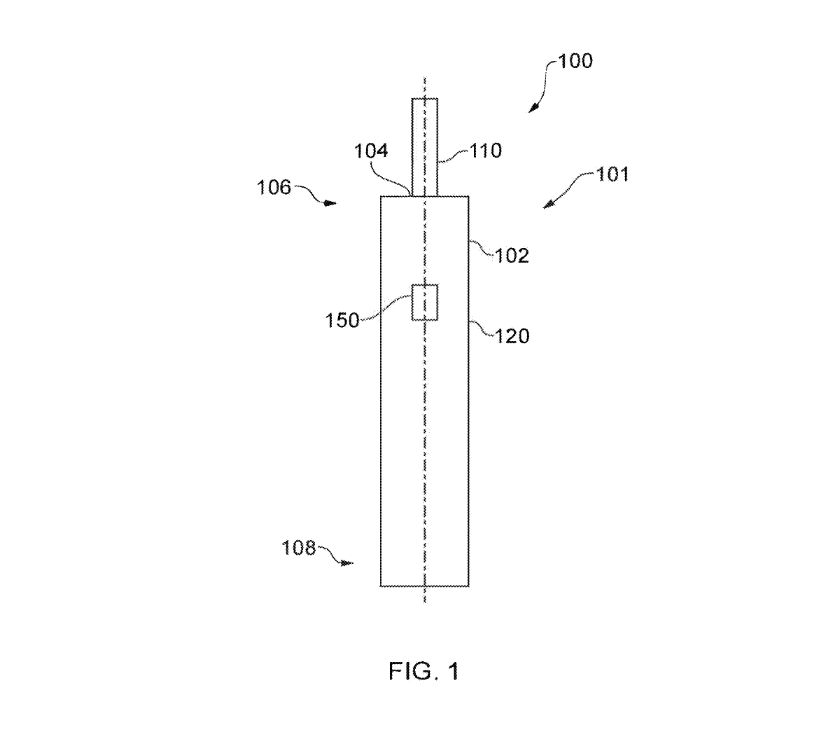

FIG. 1 shows an aerosol provision device 100 for generating aerosol from an aerosol generating material. In broad outline, the device 100 may be used to heat a replaceable article 110 comprising the aerosol generating material, to generate an aerosol or other inhalable medium which is inhaled by a user of the device 100.

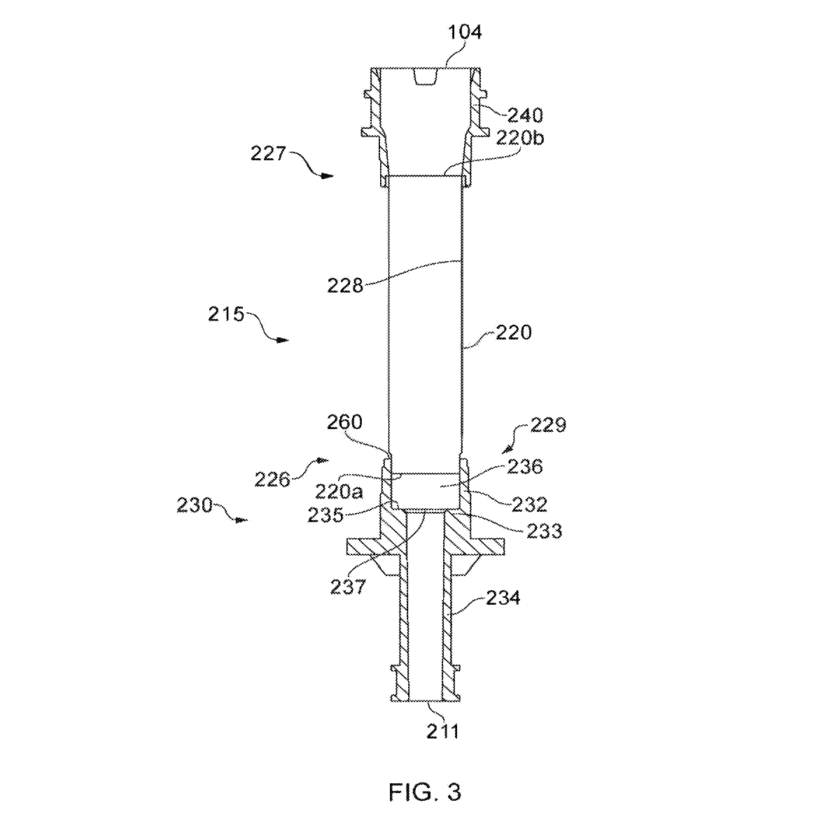

The device 100 comprises a body 102. A housing arrangement 120 surrounds and houses various components of the body 102. An article aperture 104 in formed at one end of the body 102, through which the article 110 may be inserted for heating by an aerosol generator 200 (refer to FIG. 3). In use, the article 110 may be fully or partially inserted into the aerosol generator 200 where it may be heated by one or more components of the aerosol generator 200. The article 110 and the device 100 together form an aerosol provision system 101.

The device 100 may also include a user-operable control element 150, such as a button or switch, which operates the device 100 when pressed. For example, a user may turn on the device 100 by operating the switch 150.

The body 102 has end surfaces of the device 100. The end of the device 100 closest to the article aperture 104 may be known as the proximal end (or mouth end) 106 of the device 100 because, in use, it is closest to the mouth of the user. In use, a user inserts an article 110 into the aperture 104, operates the aerosol generator 200 to begin heating the aerosol generating material and draws on the aerosol generated in the device. This causes the aerosol to flow through the device 100 along a flow path towards the proximal end of the device 100.

The other end of the device furthest away from the aperture 104 may be known as the distal end 108 of the device 100 because, in use, it is the end furthest away from the mouth of the user. As a user draws on the aerosol generated in the device, the aerosol flows in a direction towards the proximal end of the device 100. The terms proximal and distal as applied to features of the device 100 will be described by reference to the relative positioning of such features with respect to each other in a proximal-distal direction along the longitudinal axis.

As used herein, one-piece component refers to a component of the device 100 which is not separable into two or more components following assembly of the device 100. Integrally formed relates to two or more features that are formed into a one piece component during a manufacturing stage of the component.

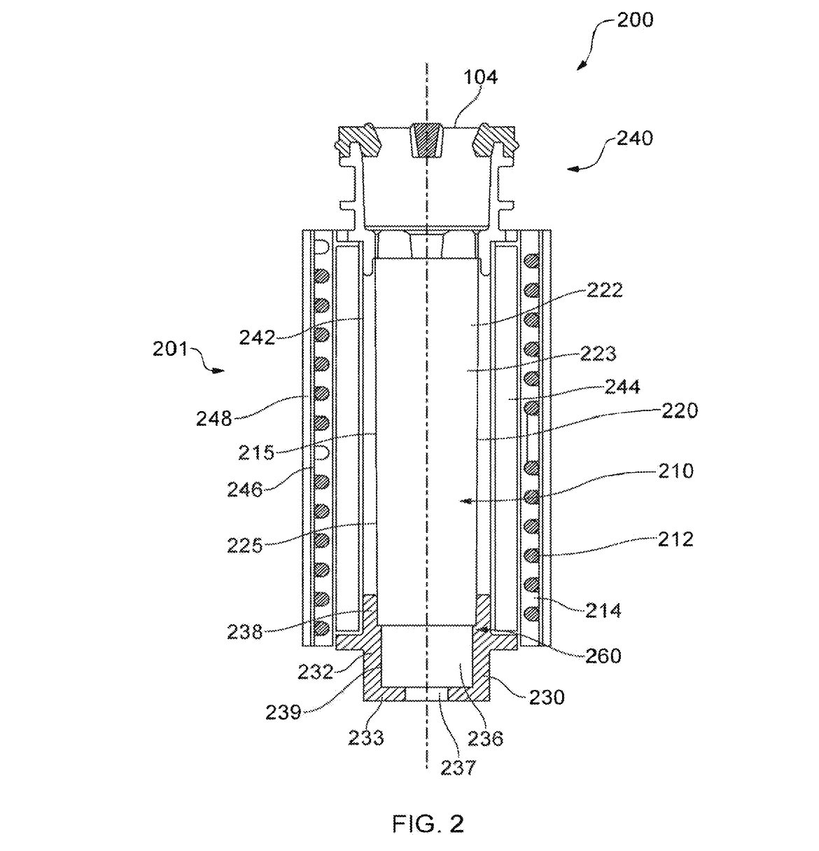

Referring to FIG. 2, the aerosol generator 200 defines a longitudinal axis, along which the article 110 may extend when inserted into the device 5. The aperture 104 is aligned on the longitudinal axis.

An air flow passage 210 extends through the aerosol generator 200. The airflow passage 210 extends to an opening 211 (refer to FIG. 3). The opening 211 acts as an air inlet. An outer cover (not shown) covers the opening 211. The outer cover in embodiments is vented to allow the flow of air into the air flow passage 210.

The aerosol generator 200 comprises various components for generating an aerosol from the received article. In one example, the article 110 is heated by a heater assembly 201 to generate aerosol. The aperture 104 is in one end, through which the article may be inserted for heating. In use, the article 110 may be fully or partially inserted into the device where it may be heated by one or more components. The apparatus includes the heating assembly 201, a controller and a power source (not shown in figures). The heating assembly 201 is configured to heat the aerosol generating material of an article 110 inserted into the device 100, such that an aerosol is generated from the aerosol generating material. The power source supplies electrical power to the heating assembly 201, and the heating assembly 201 converts the supplied electrical energy into heat energy for heating the aerosol generating material. The power source may, for example, be a battery, such as a rechargeable battery or a non-rechargeable battery. Examples of suitable batteries include, for example, a lithium battery (such as a lithium-ion battery), a nickel battery (such as a nickel–cadmium battery), and an alkaline battery. The power source may be electrically coupled to the heating assembly 201 to supply electrical power when required and under control of the controller to heat the aerosol generating material. The control circuit may be configured to activate and deactivate the heating assembly 201 based on a user operating the control element 150. For example, the controller may activate the heating assembly 201 in response to a user operating the button.

The aerosol generator 200 comprises an induction-type heater, including a magnetic field generator. The magnetic field generator comprises an inductor coil 212. The aerosol generator 200 comprises a heating element. The heating element is also known as a susceptor.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

The heating assembly 201 comprises various component to heat the aerosol generating material of the article 110 via an inductive heating process. Induction heating is a process of heating an electrically conducting heating element by electromagnetic induction. In this embodiment, the heating element is the tubular member. An induction heating assembly may comprise the inductor coil 212, acting as an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating element) suitable positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive element and the susceptor, allowing for enhanced freedom in construction and application.

The heating assembly 201 comprises a receptacle 215. The receptacle 215 acts to receive at least a portion of the article 110. The receptacle 215 comprises a heating element 220 and a base member 230. The base member 230 is at a distal end of the heating element 200. The receptacle 215 comprises a heating chamber 222. The heating element 220 is a tubular member. The heating element 220 defines a heating zone 223.

The heating element 220 is heatable by penetration with a varying magnetic field. The heating element 220 comprises electrically conducting material suitable for heating by electromagnetic induction. For example, the heating element 220 in the present arrangement is formed from a carbon steel. It will be understood that other suitable materials may be used, for example a ferromagnetic material such as iron, nickel or cobalt.

In other embodiments, the feature acting as the heating element 220 may not be limited to being inductively heated. The feature, acting as a heating element, may therefore be heatable by electrical resistance. The aerosol generator 200 may therefore comprise electrical contacts for electrical connection with the apparatus for electrically activating the heating element by passing a flow of electrical energy through the heating element.

The inductor coil 212 is a helical coil, however other arrangements are envisaged. As shown, the induction heating assembly comprises a single inductor coil. In embodiments, the number of inductor coils differs. In embodiments, the induction heating assembly comprises two or more coils. The two or more coils in the embodiments are dispose adjacent to each other and may be aligned co-axially along the axis.

In some examples, in use, the inductor coil 212 is configured to heat the heating element 220 to a temperature of between about 200 ºC and about 350 ºC, such as between about 240ºC and about 300ºC, or between about 250ºC and about 280ºC.

The inductor coil 212 is disposed external to the heating chamber 222. The inductor coil 212 encircles the heating chamber 222. The inductor coil 212 is configured to generate a varying magnetic field that penetrates the heating element 220. The inductor coil 212 is arranged coaxially with the heating chamber 222. The inductor coil assembly also comprises a coil support 214. The coil support 214 is tubular. The coil support 214 comprises a guide for the coil 212. The guide comprises a channel on an outer side of the coil support 214.

In use, alternating current is supplied to the inductor coil 212 by the power source. The alternating current in the inductor coil 212 generates a varying magnetic flux adjacent to the heating element 220. The magnetic flux generates a current in the heating element 220, which in turn causes the heating element to heat.

In the present example, the article 110 is generally cylindrical, and the heating chamber 222 is dimensioned to receive the article 110. The heating element 220 of this example is hollow and therefore defines at least part of a receptacle 222 within which aerosol generating material is received. For example, the article 110 can be inserted into the heating element 220. The heating element 220 is tubular, with a circular cross section. The heating element 220 has a generally constant diameter along its axial length. The article 110 may also comprise other components such as a filter, wrapping materials and/or a cooling structure.

The heating chamber 222 is defined by a side wall 225 of the heating element 220, a base side wall 232 and a base end wall 233. The base side wall 232 and base end wall 233 are formed by the base member 230. The side wall 225 of the heating element 220 extends axially and upstands from the base member 230. The base side wall 232 extends from the distal end of the side wall 225. The side wall 225 and the base side wall 232 extend coaxially.

The heating element 220 is elongate. The heating element 220 and the base 230 are formed of different materials. The base member 230 is mounted at a distal end 226 of the heating element 220 to form the heating chamber 222.

The side wall 225 of the heating element 220 extends axially within the device from the base member 230 at the distal end 226 towards the aperture 104 of the device 100 at a proximal end 227. The heating chamber 222 is open at the proximal end 227 to receive the article 110. The heating element 220 extends along and around and substantially coaxial with the longitudinal axis of the device 100.

FIG. 3 shows the air flow passage 210 of the aerosol generator 200. The heating element 220 has a first open end 220a and a second open and 220b. The base member 230 is at the first open end 220a. The second end 220b defines an opening through which the article 110 is inserted into the heating zone 223. The side wall 225 of the heating element 220 has at least one inner face 228.

The base member 230 acts as a first end support supporting the heating element 220. The base member 230 supports the heating element 220 at the first, distal, end. A collar 240 is provided at the second, proximal end. The collar 240 acts as a second end support supporting the heating element 220. The base member 230 and collar 240 act as receptacle supports. The collar 240 defines the aperture 104.

The heating element 220 extends between the base member 230 and the collar 240. A barrier member 242 extends between the base member 230 and the collar 240. The barrier member 242 together with the base member 230 and the collar 240 encloses the heating element 220. This acts to assist with thermally isolating the heating element 220 from other components of the device 100. The barrier member 242 is a hollow, tubular member. The barrier member 242 is fixedly mounted to base member 230 and the collar 240. The base member 230 closes the distal end of the barrier member 242. The collar 240 closes the proximal end of the barrier member 242. The barrier member 242 partially overlaps the base member 230 and the collar 240. The barrier member 242 forms a fluid seal with the base member 230 and the collar 240. In embodiments, the barrier member 242 is formed from a non-metallic material to assist with limiting interference with magnetic induction. In this particular example, the barrier member 242 is constructed from polyether ether ketone (PEEK). The base member 230 is constructed from PEEK. The collar 240 is constructed from PEEK. Other suitable materials are possible. Parts formed from such materials help ensure that the components remains rigid/solid when the heating element is heated.

The base member 230 and the collar 240 support the coil support 214. An insulation layer 244 is disposed between the barrier member 242 and the coil support 214. A ferrite shield 246 extends around the inductor coil 212. The ferrite shield acts as an electromagnetic shield. Other suitable materials may be used. The ferrite shield 246 is mounted on the coil support 214. The insulation layer 244 acts as an inner insulation layer. An outer insulation layer 248 extends around the inductor coil assembly. The outer insulating layer 248 forms a tubular arrangement.

The air flow passage 210 extends through the base member 230. The air flow passage 210 is defined by the base member 230, the heating element 220 and the collar 240. The air flow passage 210 extends from the opening 211 to the aperture 104. The base member 230 comprises a flow path member 234. The flow path member 234 extends from the base end wall 233. In embodiments the base member 230 and the flow path member 234 are separate components. In the present embodiment the flow path member 234 is a one piece component with the base member 230.

The flow path member 234 comprises a tubular member. The flow path member 234 comprises a bore. The flow path member 234 extends from the base end wall 233 to the opening 211. The flow path member 234 extends in an axial direction along its length. A shoulder 235 is defined in the base member 230. The shoulder acts as a stop to limit insertion of the article 110. The base member 230 defines an end zone 236. The end zone 236 extends from the heating zone 223 defined by the heating element 220. The end zone 236 extends from the heating zone 223. The end zone 236 extends from the distal end 226 of the heating element 220. The end zone 235 is defined by the base side wall 232. The base side wall 232 acts as a peripheral wall. The base wall 233 defines an end of the end zone 235. A flow aperture 237 in the base wall 233 defines a flow path into the end zone 236.

In embodiments, the air flow through the flow path through the device differs. As described above, the flow path is defined as a through bore through the device along a flow path member to the receptacle such that air is drawn through the article. In embodiments, the base member defines a closed end of the receptacle. The air path is defined from an open proximal end of the receptacle at the aperture 104, between the receptacle and the article to the closed end and then into the article at the closed end to flow back towards the proximal end through the article.

The base wall 233 and the base side wall 232 are formed as a one piece component. The base member 230 is is free from material heatable by penetration with a varying magnetic field.

The base member 230 and the heating element 220 intersect at a juncture 229. The base member 230 partially overlaps the heating element 220. As shown in FIG. 2, the base member 230 comprises a first section 238 having a first inner diameter and a second section 239 having a second inner diameter. The diameter of the first section 238 is greater than the diameter of the second section 239. A step is defined between the first and second sections 238, 239. The step forms a locating feature 260. The base member 230 spaces the distal end 226 of the heating element 220 from the base wall 233. The distal end 226 of the heating element 220 locates against the locating feature 260. The inner cross sectional area of the end zone 236 at least substantially corresponds to the inner cross sectional area of the heating zone 223. As such, when the article 110 is inserted the distal end of the article 110 is received in the end zone 236.

It will understand that the cross-sectional profiles of the end zone 236 and heating zone 223 may differ. For example, the diameter of the end zone 236 may be greater than the diameter of the heating zone 223. In the embodiment shown in FIG. 3, the distal end 226 of the heating element 220 defines a portion of reduced diameter. The distal end 226 of the heating element 220 is slightly tapered inwardly to be received in the proximal end of the base member 230. The end of the base member 230 acts as the locating feature 260. By such an arrangement, the distal end 226 of the heating element 220 is able to act as a retention feature. In embodiments, the base member 230 acts as a retention feature.

The base member 230 overlaps the heating element 220 between about 1mm and about 3mm. In this particular example, the overlap is 2mm. In examples, there is no overlap. The juncture 229 assists with forming fluidly sealed path. The end zone 236 extends from the heating element 220 by a distance of greater than 1 mm. The protruding extent of the peripheral wall is greater than 0.5 mm, and optionally greater than 1 mm. A length of the end zone may be between 0.5 mm and 6mm, and optionally between 1 mm and 4 mm. A length of the end zone may be greater than 4 mm.

The base member 230 is formed from an insulating material and free from a heating material. Accordingly, the distal part of the article 110 received in the end zone 235 is not heated or subjected to reduced heating compared to the part of the article received in the heating zone 223. By providing a part of reduced heated or non-heated substrate of the article, it is possible for this portion to act as a liquid collector. Condensation in the air flow passage 210 may be minimized. For induction arrangements, the base member 230 is free from material heatable by penetration with a varying magnetic field. The peripheral wall of the base member 230 defines a cavity arranged to receive at least part of the article 110.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

What is claimed is:

1. An aerosol provision device comprising:
a receptacle arranged to receive at least a portion of an article comprising aerosol generating material;
the receptacle comprising:
a heating zone arranged to receive a first part of the portion of the article receivable in the receptacle; and
an end zone extending from the heating zone,
wherein:
the heating zone is configured to be heated by a heating assembly comprising one or more heating elements arranged to heat the aerosol generating material of the article; and
the end zone is provided by a base end wall and a peripheral base side wall defining a cavity arranged to receive at least a second part of the portion of the article receivable in the receptacle which is not heated by penetration with a varying magnetic field.

2. The aerosol provision device of claim 1, wherein the one or more heating elements comprise a tubular member defining the heating zone.

3. The aerosol provision device of claim 1, wherein the heating assembly comprises one or more inductor coils.

4. The aerosol provision device of claim 1, wherein the one or more heating elements comprises a resistive heating element.

5. The aerosol provision device of claim 4, wherein the peripheral base side wall extends coaxially with a side wall of the heating element.

6. The aerosol provision device of claim 4, wherein the peripheral base side wall is part of a base member which defines the base end wall of the receptacle.

7. The aerosol provision device of claim 6, wherein the peripheral base side wall and the base end wall have been formed as a one piece component.

8. The aerosol provision device of claim 4, wherein the peripheral wall extends from the heating element.

9. The aerosol provision device of claim 4, wherein the peripheral wall partially overlaps the heating element.

10. The aerosol provision device of claim 6, wherein the base member defines a closed end of the receptacle and an air path is defined from an open proximal end of the receptacle at an aperture between the receptacle and the article to the closed end and then into the article at the closed end to flow back towards the proximal end through the article.

11. The aerosol provision device of claim 10, wherein the base member is an end support arranged to support an end of a heating element of the heating assembly.

12. The aerosol provision device of claim 11, wherein the end support is a first end support at a first end of the heating element and the device comprises a second end support at a second end of the heating element.

13. The aerosol provision device of claim 1, wherein an axial length of the heating zone is greater than an axial length of the end zone.

14. The aerosol provision device of claim 13, wherein the axial length of the heating zone is at least four times greater than an axial length of the end zone.

15. The aerosol provision device of claim 1, wherein a cross sectional profile of the end zone corresponds to a cross sectional profile of the heating zone.

16. The aerosol provision device of claim 1, wherein the peripheral base side wall is formed from an insulating material.

17. The aerosol provision device of claim 16, wherein the peripheral base side wall comprises polyether ether ketone (PEEK).

18. The aerosol provision device of claim of claim 1, wherein a length of the end zone is greater than 4 mm.
